(19) United States
(12) Patent Application Publication
(10) Pub. No.: US 2013/0035230 A1
(43) Pub. Date: Feb. 7, 2013

(54) USE OF FUNGAL ORGANISM PYTHIUM OLIGANDRUM

(71) Applicant: Martin Suchánek, Praha (CZ)

(72) Inventor: Martin Suchánek, Praha (CZ)

(21) Appl. No.: 13/511,556

(22) PCT Filed: Dec. 11, 2009
(86) PCT No.: PCT/CZ09/00152

§ 371 Date: Jul. 11, 2012

(30) Foreign Application Priority Data
Nov. 27, 2009 (CZ) PV 2009-794

(51) Int. Cl. A01N 63/04; A01P 1/00; A01P 3/00

(52) U.S. Cl. 504/101

(57) ABSTRACT

The invention concerns the application of the fungal organism Pythium oligandrum as a strong mycoparasite in connection with the applicable inorganic or organic carrier of the efficient agens as a preparation for additional fertilization and for protection of plants against the originators of microbial diseases and as a preparation for the elimination of post-harvest losses and losses during storage of commodities coming from plant or animal production, including the preparation for the liquidation of wood-destroying fungi. The application of the preparation for the protection of plants against the originators of microbial diseases can also be performed in the form of aerial spraying.

### FIELD OF THE INVENTION

The invention relates to the use of the fungal organism Pythium oligandrum in connection with the applicable agens carrier, especially in the area of plant production, in particular it concerns the new application methods applicable in fertilization and protection of plants. The invention also concerns the new application method for the elimination of originators of post-harvest losses caused by fungal diseases, yeasts and bacteria and for the liquidation of wood-destroying fungi. The application of the invention may also be realized in the form of aerial spraying.

### BACKGROUND OF THE INVENTION

After the chemical way of seed pickling against fungal diseases with fungicides, a new way of biological protection started to be used in the seventies of the 20^{th} century, which used living cells of antagonistic micro organism against the phytopathogens. It concerns e.g. preparation stimulating, in case of application to the seeds of sugar beet, the growth of growing plants and protecting them against rotting pursuant to CZ AO No. 199906 issued by the Institute for inventions and discoveries in Prague/1985/as well as the following inventions of Veselý D., S I. Hejdanek/1978 a/Type of production of the preparation stimulating, in case of application to the seeds of sugar beet, the growth of growing plants and protecting them against rotting, CZ AO No. 204208 issued by the Institute for inventions and discoveries in Prague/1983/and Veselý D., S I. Hejdánek/1978 b/Preparation for the protection of sugar beet against rotting on the basis of oospora of the mycoparasite Pythium oligandrum, CZ AO No. 213659 issued by the Institute for inventions and discoveries in Prague/1984/, when the latest said CZ AO No. 213659 was patented in 12 other countries: U.S. Pat. No. 4,259,317, Canada 1132270, Federal Republic of Germany 2927224, German Democratic Republic 157491, UK 2027448, France 7917494, Japan 1337470, Denmark 156291, Belgium 877474, Austria 363734, Italy 1122032, Hungary 183040 and it solves the protection against rotting of sugar beet/damping off, which are caused by the soil phytopathogenic fungi. The same issues are also solved with another invention Stanek M., D. Veselý/1983/Preparation for protection of growing plants of sugar beet against rotting, CZ AO No. 247378 issued in Prague/1987/and also the utility models Veselý; D./1993/Preparation for support of growth of plants and/or their protection/CZ utility model No. 393/and in Slovakia the registered utility model Veselý D.,/1994/Preparation for support of growth of plants and/or their protection, SK utility model No. 429 solve also exclusively the protection against damping-off of germinating plants and with focus on forest nursery.

From other foreign patent literature, 2 patents were granted in the USA for the biological protection against damping-off of germinating plants: Baker R., R. Lifshitz/1983/Isolates of pythium species which are antagonistic to Pythium ultimum, which deals with the utilization of species of Pythium sp., which are antagonistic to the soil phytopathogenic fungus Pythium ultimum, causing damping-off of germinating plants/patent granted in 1986/and also the patent: Martin F. N./1996/Biocontrol of fungal soilbome pathogens by Pythium oligandrum/patent granted in 1999/, which identifies 3 non-pathogenic isolates of the fungal organism Pythium oligandrum efficient against damping-off of germinating and growing plants of tomato and other vegetable species, which are caused by the phytopathogenic fungal organisms from the Pythium family.

There are also various scientific publications about the topic of application of the fungal organism of Pythium oligandrum against damping-off of various growing plants including vegetable species: for example successful application of Pythium oligandrum for the protection of cucumber against damping-off, which is caused by the phytopathogen Pythium splendens: Larsen H, 1985 Bekaempelse of Pythium med specielt henblik pa biologisk bekaempelse vha antagonister. Thesis. Veterinary and Agriculture Univerzity, Copenhagen, Denmark; also Thinggaard K. 1985, Interspecific antagonism: The use of Pythium oligandrum to control root rot of cucumber caused by Pythium splendens. 6^{th} Scandinavian postgraduate course in plant pathology. “Sene pathosystems”, 21-28 Nov. 1985 in Sverige and Thinggaard K., K Larsen and J. Hockenhull/1988/Antagonistic Pythium against pathogenic Pythium on cucumber roots. Bulletin OEPP/EPPO Bulletin 18, pp. 91-94.

In the scientific literature, Pythium oligandrum is always identified in connection with diseases of roots of growing plants and with mycoparazitism as the only type of effect, refer to e.g. Veselý D./1987/Biological control of damping-off pathogens by treating sugar-beet seed with a powdery preparation of the mycoparasite Pythium oligandrum in large-scale field trials, pp. 445-449; In: Van\check{c}ura V., F. Kunc/eds./Interrelationships between microorganisms and plants in soil. Proceedings of an International Symposium Liblice, Czechoslovakia, Jun. 22-27, 1987, Academia Publishing House of the Czechoslovak Academy of Sciences, Elsevier Science Publishers, Amsterdam, The Netherlands, Prague 1989, identifies successful utilization of the bio-preparation on the basis of P. oligandrum against damping-off of beet plants. On the example of damping-off of saplings of cucumber, Kratka J. Bergmanová, A. Kudelova 1994 Effect of Pythium oligandrum and Pythium ultimum on biochemical changes in cucumber/Cucumis sativus L./Ztschr. f. Pfl. Krankh. u. Pfl. Schutz, 101/4/, pp. 406-413 studied relationships between the myco-parasite P. oligandrum and the plant treated with it, which is demonstrated e.g. by the stimulation of growth of plants. Al-Rawahi A. K., J. G. Hancock/1997/Rhizosphere Competence of Pythium oligandrum, Phytopathology Vol., 87, 9; 951-959 studied the colonization of rhizosphere and non-rhizosphere soil with the said fungal organism on the roots of saplings. Benhamou N., P. Rey, M. Chérif, J. Hockenhull and Y. Tirilly/1997/Treatment with the Mycoparasite Pythium oligandrum Triggers Induction of Defence-related reactions in Tomato Roots When Challenged with Fusarium oxysporum f. s. radicis-lycopersici. Phytopathology, Vol. 87, 1: 108-122 submitted proofs that Pythium oligandrum initiates defence responses in the tomato roots against the phytopathogenic fungus Fusarium oxysporum f. sp. radicis-lycopersici as the complementary tape of effect of the mycoparazitism. Mi\check{s}a D./1997/Efficiency of biological preparations against grey mould/Botrytis cinerea Pers. et Fries/on grapevine. Proceedings of the XIV Slovak and Czech Plant Protection Conference in Nitra 3^{rd}-4^{th} Sep. 1997,pp. 294-296, tested the efficiency of the preparation with Pythium oligandrum as the contact fungicide against the grey mould on grapes of the grapevine. Veselý D./1998/Pythium oligandrum as a biological agent stimulating seed-potato germination and suppressing potato late blight primary infection, 5. 2. 58. 7^{th} International Congress of Plant Pathology, Edinburgh: by the treatment of the seedling tubers of potatoes, growth of sprouts and rootlets was stimulated and the development of symptoms of the primary infection of potato late blight was slowed down. Benhamou N., P. Rey, K. Picard, Y. Tirilly/1999/Ultrastructural and Cytochemical Aspects of the interaction Between the Myco-parasite Pythium oligandrum and Soilbome Plant Pathogens, Phytopathology, Col. 89 6: 506-517 studied the interactions between the oomycetes Pythium oligandrum and various soil oomycetes and plants pathogens/P. ultimum, P. aphanidermatum, F. oxysporum f sp. radicis-lycopersici, Verticillium albo-atrum, Rhizoctonia solani and Phytophthora megasperma/They found out that at least two different mechanisms seemed to be responsible in the process of the attack of the oomycet P. oligandrum on the pathogens: mycoparazitism and antibiosis. Veselý D./2000/Polyversum as an effective seed dresser in wheat, p. 120. Proceedings of 13^{th} International EFOAM Scientific conference/Alf Oldi T., W. Lockeretz, V. Niggli/eds./28-31 Aug. 2000, Basel, stated that Pythium oligandrum as the seed dresser improved health conditions of roots of winter wheat, whereby it also increased yields.

In addition to the aforesaid author's certifications and patents of the inventions, two scientific publications deal with the type of production of the preparation based on the application of the fungal organism Pythium oligandrum: Veselý D., S. Hejdánek/1984/Microbial relations of Pythium oligandrum and Problems in the Use of This Organism for the Biological Control of Damping-off in Sugar-beet. Zbl. Mikrobioi. 139, pp. 257-265, compare the advantages and problems of stationary surface cultivation and submersion cultivations. Mc Quilken M. P., J. M. Whipps and R. C. Cooke/1990/Oospores of the biocontrol agent Pythium oligandrum bulk produced in liquid culture. Mycol. Res. 94, 5, pp. 613-616 developed the method of production of oospores of P. oligandrum in static and aerated cultivation in liquid medium.

Since 1997, the bio-fungicide preparation with the growth-stimulating effect, the efficient substance of which is the fungal organism Pythium oligandrum Drechsler, has been manufactured and commercially distributed by the company Biopreparaty, s.r.o. in approximately fifteen states of the world with various trade names. One of the names is bio-fungicide Polyversum.

### SUMMARY OF THE INVENTION

The nature of the invention is, as outlined above, the use of the fungal organism Pythium oligandrum as a strong mycoparasite in connection with the applicable inorganic or organic carrier of the efficient agens in the form of the preparation for the application in the area of plant production for fertilization or protection against pests, for storage of products and seeds but also for the liquidation of wood-destroying fungi.

Surprisingly, it has been found out that:
1. The new application method of additional fertilization under the foot (fertilization under the root) when sowing cultural plants in the solution or in the form of granules of the preparation for the protection of plants, one of the efficient substances of which is Pythium oligandrum, considerably improves sprouting of the seed corn, strengthens the development of the root system and the formation of strong roots with rich root hairs. It results in higher intake of nutrition, moisture and strengthening of plants. Further to that, better conditions of growths after winter and their increased resistance to unfavourable weather conditions in spring. The growths have no significant deficits of nutrients because their roots reach deeper into the soil profile. This effect is best visible in the places with high level of organic nutrition where the plants do not have a natural need to form ample roots. In a dry period, these very plants can suffer from reduction of pods because they have smaller intake of water. The application of the preparation, the efficient substance of which is Pythium oligaridrum, under the foot for the protection of the plants considerably alleviated such reductions.

In field tests, the following was observed:
Considerable strengthening of the root neck. In spring, the plants are stronger and have natural growth prerequisites for higher yields.
Intense support of branching. Increasing the fructiferous level of pods results in the increase of the number of seeds of the plant.
Increased resistance to frost. It is caused by the simultaneous increasing of intake of concurrently provided N, P, K and B nutrition and increasing the concentration of such organic, reserve substances, which significantly influence higher frost resistance of plants.

The method of application of the fertilization under the root with common fertilizers in various formulations with a different ratio of composition of nutrients is common and wildly used throughout the world. What is brand new is the combination of the said procedure with the application of the bio-fungicidal microbial agens Pythium oligandrum.
2. There are new possibilities of formulation modifications of the preparation for the protection of plants, the efficient substance of which is Pythium oligandrum. What is new in comparison with the current state-of-the-art is the application of the solution with Pythium oligandrum on the slightly heated granules containing the fertilizers or in the form of a paste or gel, e.g. grafting wax.
3. There are new possibilities of mixtures of preparations for the protection of plants, the efficient substance of which is Pythium oligandrum in combination e.g. with pesticide fertilizers, adhesives and adjutants. Both in practice and in laboratory, it has been proven that thick-walled reproduction organs of the fungal organism Pythium oligandrum, if they are exposed to short-term effect of registered insecticides, herbicides and fertilizers, do not show symptoms of decreased virulence. By the application of the aforesaid property, it is possible to ensure in practice a significant level of savings for the end user in particular in case of the application of the combination—tankmix on the treated growths.
4. There are new application methods for the application of the preparation, the efficient substance of which is Pythium oligandrum for aerial applications of spraying the preparations for the protection of plants. During the realization of toxicological studies, it was repeatedly proven by the manufacturer, the company Biopreparáty s.r.o. in the experiments (by GLP accredited laboratories) that the mixture of propagules of the fungal organism Pythium oligandrum have zero toxicity on non-targeted organism and do not form dangerous residua. The said tests were performed within the registrations of the efficient substance of the fungal organism Pythium oligandrum of the tribe M1 in the EU and the tribe DV 74 in ISDPA. All tribes of Pythium oligandrum have the aforesaid toxicological properties. The confirmed fact, i.e. zero toxicity, is the crucial argument for the safe aerial application of the formulated and registered bio-fungicide (Polyversum, Green Doctor) on the cultural plants and forest growths. In September 2009, EFSA submitted a proposal to the European Parliament concerning new rules for the reduction of application of pesticides, a part of which was also a ban on aerial applications of pesticides. The European Parliament passed the draft in the second reading. The Regulation of the European Parliament and of the Council became valid and is marked PE-CONS 3607 and PE-CONS 3608. The reason for the limitation of aerial applications is especially dangerous toxicity of the current chemical preparations for the plant protection. Ecological safety of bio-fungicides with the fungal organism Pythium oligandrum and advantageous economic level of aerial applications can form strong arguments against the ban on aerial applications. Safety preparations with the efficient substance Pythium oligandrum will be applied aerially anew in a demonstrable way.
5. There are new applications of preparations, the efficient substance of which is Pythium oligandrum, for the prevention of occurrence of originators of microbial diseases causing post-harvest losses before and during storage of products and seeds of cultural plants and all other commodities of both plant and animal agricultural production.

Surprisingly it has been demonstrated that the application of the preparation, the efficient substance of which is the fungal organism Pythium oligandrum, significantly suppresses the originators of fungal, yeast and bacterial diseases of stored products of the agricultural production (e.g. vegetables, fruit, nuts, cereals, meat and meat products, feeding mixtures for animals and other agricultural commodities) and semi-products and final products before the end application by the consumer (people, animals). The application of the fungal organism Pythium oligandrum before and after the harvest (e.g. in case of cereals) results in a decreased occurrence of residua of fungi (mycotoxins) of e.g. the family Fusarium (aflatoxins) in agricultural commodities. Nowadays, the presence of mycotoxins in the food chain has been a real health risk to the consumer.

The applications extended the storage life; thanks to the elimination of rot and mould processes, the storage and preservation possibilities of crops and foodstuffs have improved rapidly.
6. During the application of the preparation, the efficient substance of which is Pythium oligandrum, on the walls of warehouses and surfaces of the storage technology (e.g. silos, warehouses of foodstuffs with controlled as well as uncontrolled atmosphere, racks and stackers), cellars, in the food-processing facilities (e.g. digester houses, preparation rooms, packing rooms), surface of packing for storage of foodstuffs and semi-products (e.g. storage transport boxes and cases), on the surface of transport packing (e.g. cases for fruit, boxes for bananas), on the surface of sales racks and on both internal and external surfaces of sales packing, pathogenic microflora, which caused rot decay, was demonstrably suppressed. The said applications considerably extended the storage period of stored agricultural commodities.
7. It is possible to apply the fungal organism Pythium oligandrum on paper cellulose materials, which are used directly or as a semi-product for the production of packing materials (e.g. fine paper packages of piece fruit and vegetables, bags and carrier bags for fruit and vegetables).
8. That the fungal organism Pythium oligandrum parasites on: Serpula lacrymans, Coniophora puteana, Gloeophyllum sepiarium, Fibroporia Vaillantii as well as other wood-destroying fungi. However, prevention is important in the system of treatment of wood species by means of the fungus Pythium oligandrum before they are attacked by the wood-destroying fungus itself. However, laboratory experiments confirmed that even during the attack on the wood by a wood-destroying fungus, Pythium oligandrum can prevent from further growth of the pathogen.

Pythium oligandrum may be used for the aforesaid purposes for the application in aqueous solutions, namely in the form of dry mixtures or liquid cultures, in powder or in granules.

### EXAMPLES

### The Application in Aqueous Solutions in the Form of Dry Mixtures.

For the application in aqueous solutions in the form of dry mixtures (powders) as wettable powders intended for application in the form of suspension after dispersion in water, both mineral and organic materials may be used as the inert filling of such powders. As suitable filling materials for such application, e.g. mineral and synthetic filling materials produced from silica, natural clay, vermiculite and various silicate materials can be used. As other suitable filling materials, we can also identify sulphates (calcium sulphate), silicates (magnesium silicate): As surface active substance in these wetting agents, there are two types of tensides: anion (anion-active, anionic) and non-ion (non-ionogen, non-ionic). Anion tensides are especially of the type of alkyl sulphates, alkyl- or alken sulphonan and alkyl benzene sulphonan. Non-ion tensides are especially products of higher alcohols but also alkyl phenols and aliphatic acids with alkylene oxide (i.e. either with ethylene oxide or, as the case may be, propylene oxide). The most preferred are wetting agents of alkyl-benzene and alkyl-naphthalene sulphonates, sulphates, aliphatic alcohols, amines or amides of acid, long chains of esters of sodium isethionate, esters of 45 sodium succinate, sulphates or sulphonated of vegetable oils and ditertiary non-saturated with glycols. The preferred dispergators are methyl cellulose, polyvinyl alcohol, lignin sulphonate, polymeric alkyl naphthalene sulphonates, sodium naphthalene sulphonates, polymethylene bisnaphthalene sulphonate and natrium-50-N-methyl-N-(long chain of the acid).

Such wettable powders are represented usually in the concentration from 0.5 percentage by weight to 99 percentage by weight. if required, a part may be replaced with inhibitor of corrosion or anti-foaming or both.

### Application in Liquid Cultures

For the application in liquid cultures, the most preferred wetting agents are alkyl benzene and alkyl naphthalene sulphonates, sulphated aliphatic alcohols, amines or amides of acids, long chains of esters of sodium isethionate, esters of 45 sodium sulpho-succinate, sulphated or sulphonated vegetable oils.

### Application in Emulsified Oils

Emulsified oils are usually solutions or suspensions of the active material in waterless mixable solvents together with surface-active substances and/or emulsifiers. Emulsified oil may be mixed with the active substance, with an organic solvent. The following are suitable: chlorinated solvents, water non-miscible ethers, esters, ketones or in a mixture with aromatic hydrocarbons.

The most suitable emulsifiers for emulsified oil are long chains of alkyl or mercaptan polyethoxy alcohols, alkyl acryl polyethoxy alcohols, sorbitan-aliphatic acids, esters, ethers poly sorbitan with esters of aliphatic acids, polyethylene glycol with esters of aliphatic acids of colophony, aliphatic alkylol amides. Condensates of calcium and amine salt of aliphatic alcohols of sulphates, oil sulphonates dissoluble in oil, or preferably mixtures of the said components should form approximately from 1 to 90 percent by weight from the total composition.

### Application in Granules

Granules are physically stable, particles of the composition including propagules of the efficient substance Pythium oligandrum with an organic or inorganic carrier. For the purpose of washing out of the efficient substance from the granule, surface active substances can be added.

### Application in Wetting Agents

Such wetting agents are used as suitable wetting agents that are of an anion or non-ion type.

### Type of Preparation

The fungal organism Pythium oligandrum is grown in common fermenters on corn media without supplying further nutrition. After the removal of the supernatant by centrifugal operation or in the evaporator, the sediment with the production of oospora is dried. It is possible to separate oospora from the supernatant in the spray drier in an advantageous way. The advantage of this way is obtaining a clean concentrate of oospora, virtually without presence of the used nutrient medium and also mycelium that is destroyed in the aforesaid handling/drying/separation. Such obtained concentrate can be homogenized at any time with the applicable inorganic or organic carrier of the efficient agens/internal filling material/.

Testing of biological efficiency of the preparation according to the invention

All tests were performed by the company Biopreparáty spot. s. r. o. in its research laboratory.

### Accreditation of the Certification.

The tests concerning the content of the active substance Pythium oligandrum were performed. Further to that, the development and progress of efficiency on moulds and phytoparasites and their mutual interaction, which was monitored, were detected. The company Biopreparáty spot. s. r. o. ensures cultivation and research of new cultivars of the microorganism Pythium oligandrum. Thanks to the application of various selective soils, the microorganism Pythium oligandrum is cultivated for certain applications so that their impact is as efficient as possible. Another process, which is performed by this company, is the actual incubation and fermentation of the cultures of Pythium oligandrum.

### FIELD OF APPLICATION

The invention can be used as a new application method of additional fertilization of cultural plants, as a new application method of their protection, also in the form of aerial spraying, including its application in the prevention of occurrence of originators of microbial diseases during the storage of products and seeds and other commodities of plant and animal production and for the liquidation of wood-destroying fungi.

1. The use of the fungal organism Pythium oligandrum with the applicable inorganic and/or organic carrier of the efficient agens in the form of the preparation of the application under the roots during sowing of cultural plants as a preparation for additional fertilization and for the protection of plants against the originators of microbial diseases and/or as a preparation for the prevention of occurrence of the originators of microbial diseases causing post-harvest losses before and during storage of products and seeds of cultural plants and all other food and dietary commodities originating from the plant and animal production and/or as a preparation, which contributes, by the suppressing of the originators of microbial diseases of plants, to decreasing of the content of undesired and/or toxic metabolites and/or mycotoxins produced by the originators of microbial diseases in plant and animal products and/or as a preparation for the liquidation of wood-destroying fungi.

2. The use according to the claim 1 for the protection of plants against the originators of microbial diseases in the form of aerial spraying.
